(19) United States
(12) Patent Application Publication
(10) Pub. No.: US 2026/0290725 A1
(43) Pub. Date: Sep. 24, 2026

(54) SWITCH DEVICE

(71) Applicant: KABUSHIKI KAISHA TOKAI RIKA DENKI SEISAKUSHO, Aichi (JP)

(72) Inventors: Yosuke HATADA, Aichi (JP); Yuta YAMANISHI, Aichi (JP); Masahiro KATO, Aichi (JP); Sota SUZUKI, Aichi (JP)

(73) Assignee: KABUSHIKI KAISHA TOKAI RIKA DENKI SEISAKUSHO, Aichi (JP)

(21) Appl. No.: 19/472,866

(22) PCT Filed: Mar. 27, 2024
(86) PCT No.: PCT/JP2024/012300

§ 371 Date: Oct. 6, 2025

(30) Foreign Application Priority Data
Apr. 10, 2023 (JP) 2023-063545

(51) Int. Cl. H01H 19/20; H01H 3/08

(52) U.S. Cl. CPC H01H 19/20; H01H 3/08

(57) ABSTRACT

A knob (31) is turnable about an axis. A cam mechanism (36) has a cam face (360) configured to displace a slider (34) in a direction along the axis in accordance with a turning action of the knob (31). A click-feeling generation mechanism (37) is configured to increase resistance to an actuation for turning the knob (31) as the slider (34) arrives each of multiple prescribed positions. The cam face (360) has a first section (S1) and a second section (S2) in which a displacement amount of the slider (34) per unit turning angle of the knob (31) is changed. The first section (S1) and the second section (S2) are associated with a click-feeling generative position at which the resistance is increased by the click-feeling generation mechanism (37).

### FIELD

The presently disclosed subject matter relates to a switch device configured to select any one of multiple controlled states based on actuation of a knob that is turnable about an axis.

### BACKGROUND

Japanese Patent Publication No. 2011-210598A discloses a switch device adapted to be installed in a vehicle. The switch device includes a knob that is turnable about an axis. As the knob is turned, a movable conductive contact provided on the knob establishes an electrical connection state with any one of multiple stationary conductive contacts. The multiple electrical connection states are associated with different controlled states.

### SUMMARY OF THE INVENTION

### Technical Problem

It is required to improve adaptability with respect to a specification change of the switch device 1 in accordance with a change of an object to be controlled.

### Solution to Problem

An illustrative aspect of the presently disclosed subject matter may provide a switch device, comprising:
a knob that is turnable about an axis;
a slider;
a cam mechanism having a cam face configured to displace the slider in a direction along the axis in accordance with a turning action of the knob; and
a click-feeling generation mechanism configured to increase resistance to an actuation for turning the knob as the slider arrives each of multiple prescribed positions;
wherein the cam face has multiple sections in which a displacement amount of the slider per unit turning angle of the knob is changed; and
wherein the multiple sections are associated with a click-feeling generative position at which the resistance is increased by the click-feeling generation mechanism.

According to the configuration as described above, it is possible to improve flexibility as for the relationship between the turning angle of the knob between the click-feeling generative positions associated with the transition between different controlled states and the displacement amount of the slider, without applying significant change to the configuration of the slider or the click-feeling generation mechanism.

For example, even if the click-feeling generative positions are determined with equal turning angular intervals relative to the knob, a displacement amount of the slider associated with a transition between certain controlled states can be made different from a displacement amount of the slider associated with a transition between other controlled states. In other words, it is possible to realize different motions of the slider based on the same actuation of the knob without changing the configuration of the click-feeling generation mechanism.

Alternatively, an actuation amount of the knob associated with a transition between certain controlled states can be made different from an actuation amount of the knob associated with a transition between other controlled states without changing the displacement amount of the slider. In other words, it is possible to realize different actuation feelings of the knob for causing the slider to perform the same motion without changing the configuration of the slider.

Accordingly, it is possible to improve adaptability with respect to a specification change of the switch device in accordance with a change of an object to be controlled.

### BRIEF DESCRIPTION OF DRAWINGS

FIG. 1 illustrates an appearance of a switch device according to an exemplary embodiment.

FIG. 2 illustrates a state that a knob is removed from the switch device of FIG. 1.

FIG. 3 illustrates an appearance of the switch device of FIG. 1 as viewed from a direction along a turning axis.

FIG. 4 illustrates a cross section along a line IV-IV of FIG. 3 as viewed from an arrowed direction.

FIG. 5 illustrates an action of the switch device of FIG. 1.

FIG. 6 illustrates an action of the switch device of FIG. 1.

FIG. 7 illustrates an action of the switch device of FIG. 1.

FIG. 8 illustrates an action of a switch device according to a comparative example.

FIG. 9 illustrates an action of the switch device according to the comparative example.

FIG. 10 illustrates an action of the switch device according to the comparative example.

FIG. 11 illustrates an action of a switch device according to another exemplary embodiment.

FIG. 12 illustrates an action of a switch device according to another exemplary embodiment.

FIG. 13 illustrates an action of a switch device according to another exemplary embodiment.

FIG. 14 illustrates another exemplary configuration of a cam mechanism of FIG. 4.

### DESCRIPTION OF EMBODIMENTS

Exemplary embodiments will be described in detail below with reference to the accompanying drawings. In each of the drawings, the scale is appropriately changed in order to make each element as illustrated have a recognizable size.

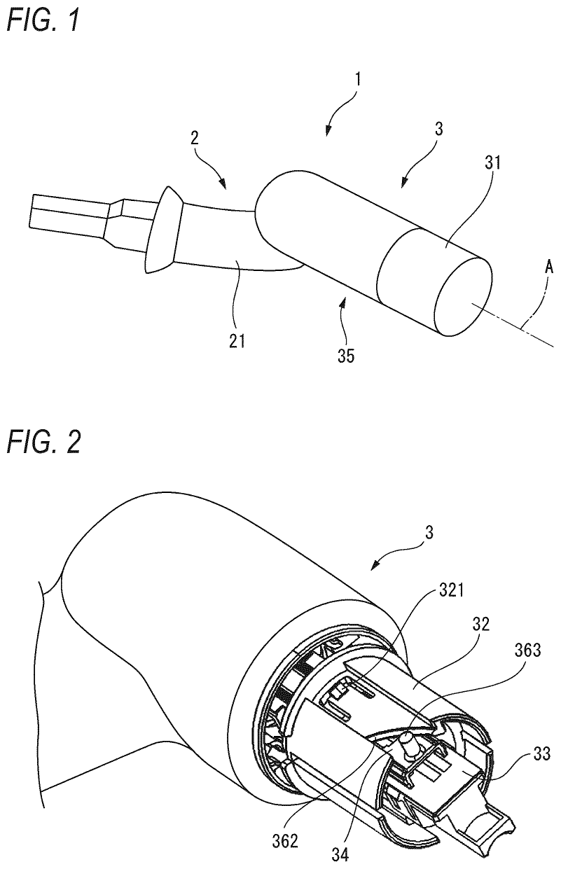

FIG. 1 illustrates an appearance of a switch device 1 according to an exemplary embodiment. The switch device 1 is installed in a vehicle to constitute a part of a steering device for changing a course of the vehicle.

The switch device 1 includes a lever switch 2. The lever switch 2 includes a lever 21 capable of being displaced with respect to the steering device. The lever switch 2 accepts an actuation involving the displacement in order to turn on a direction indicator of the vehicle, for example.

The switch device 1 includes a knob switch 3. The knob switch 3 includes a knob 31 that is turnable about a turning axis A. The knob 31 accepts an actuation involving the turning in order to change, for example, a lighting state of a headlight of the vehicle. The headlight is an example of a device installed in a vehicle. The lighting state is an example of a controlled state.

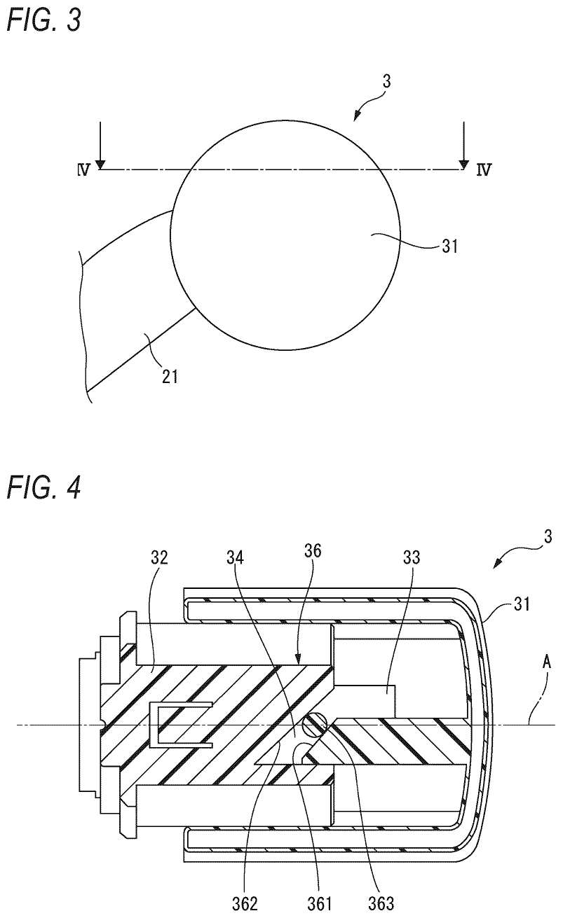

FIG. 2 illustrates an appearance of the knob switch 3 in a state that the knob 31 is removed. FIG. 3 illustrates an appearance of the knob switch 3 viewed from a direction along the turning axis A. FIG. 4 illustrates a cross-section viewed from an arrowed direction along the line IV-IV in FIG. 3.

As illustrated in FIGS. 2 and 4, the knob switch 3 includes a rotor 32. The rotor 32 includes an engagement member 321. As the knob 31 is attached to the rotor 32, the engagement member 321 engages with a mating member (not illustrated) provided on an inner peripheral wall of the knob 31. As a result, the rotor 32 is enabled to turn about the turning axis A together with the knob 31.

As illustrated in FIGS. 1 and 2, the knob switch 3 includes a board 33, a slider 34, and a housing 35. The board 33 and the housing 35 have a shape elongated in a direction along the turning axis A. The slider 34 is mounted on the board 33 and is then housed in the housing 35. Multiple stationary contacts are disposed on the board 33. A movable contact is provided on the slider 34.

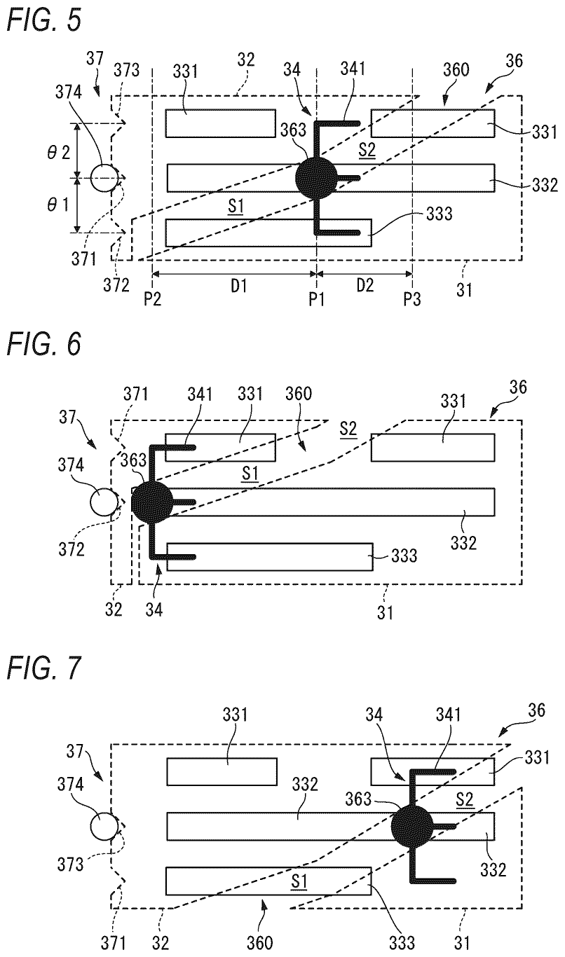

FIG. 5 schematically illustrates a positional relationship between multiple stationary contacts on the board 33 and the movable contact 341 of the slider 34. The multiple stationary contacts include a first contact 331, a second contact 332, and a third contact 333. Each of the first contact 331, the second contact 332, and the third contact 333 is formed of a conductive material and is electrically insulated from each other. Each of the first contact 331, the second contact 332, and the third contact 333 extends in a direction along the turning axis A. The movable contact 341 is formed of a conductive material.

In a first position P1 of the slider 34 illustrated in FIG. 5, the movable contact 341 establishes an electrical connection with the second contact 332 and the third contact 333.

As illustrated in FIG. 4, the knob switch 3 includes a cam mechanism 36. The cam mechanism 36 includes a first cam face 361, a second cam face 362, and a cam follower 363. The first cam face 361 is formed as a part of the knob 31. As illustrated in FIG. 2, the second cam face 362 is formed as a part of the rotor 32, and the cam follower 363 is formed as a part of the slider 34.

As the knob 31 is attached to the rotor 32, the cam follower 363 is disposed between the first cam face 361 and the second cam face 362. In the following descriptions, the first cam face 361 and the second cam face 362 will be collectively referred to as a “cam face 360” as required.

The cam face 360 is configured to displace the cam follower 363 in a direction along the turning axis A in accordance with the turning action of the knob 31. In other words, the cam mechanism 36 is configured to displace the slider 34 on the board 33 along the turning axis A in accordance with the turning action of the knob 31.

FIG. 6 illustrates a case where the knob 31 is turned clockwise in FIG. 3 from the state illustrated in FIG. 5. The cam follower 363 is displaced leftward in FIG. 6 along the cam face 360, so that the slider 34 moves to a second position P2 in FIG. 5. The movable contact 341 in this state establishes electrical connection with the first contact 331, the second contact 332, and the third contact 333.

FIG. 7 illustrates a case where the knob 31 is turned counterclockwise in FIG. 3 from the state illustrated in FIG. 5. The cam follower 363 is displaced rightward in FIG. 7 along the cam face 360, so that the slider 34 moves to a third position P3 in FIG. 5. In this state, the movable contact 341 establishes electrical connection with the first contact 331 and the second contact 332.

In other words, the movable contact 341 establishes multiple different electrical connection states with the multiple stationary contacts in accordance with the displacement of the slider 34. The multiple electrical connection states are associated with multiple controlled states. The knob switch 3 outputs a signal corresponding to the electrical connection state as established. In this example, the first position P1, the second position P2, and the third position P3 of the slider 34 are associated with different lighting operations of the headlight. Based on the signal outputted from the knob switch 3, the lighting operation of the headlight is controlled. Each of the first position P1, the second position P2, and the third position P3 is an example of a prescribed position of the slider 34.

The movable contact 341 according to the present example is configured to be electrically connected to at least two stationary contacts regardless of the position of the slider 34. However, depending on the specification of the knob switch 3, the movable contact 341 may be configured to establish an electrical connection with at least one stationary contact.

As illustrated in FIG. 5, the knob switch 3 includes a click-feeling generation mechanism 37. The click-feeling generation mechanism 37 is configured to increase resistance to the turning actuation of the knob 31 when the slider 34 reaches each of the first position P1, the second position P2, and the third position P3.

Specifically, the click-feeling generation mechanism 37 includes a first recess 371, a second recess 372, a third recess 373, and an engagement member 374. The first recess 371, the second recess 372, and the third recess 373 are formed in a side wall of the rotor 32. The engagement member 374 is urged toward the side wall of the rotor 32 by an urging member (not illustrated).

When the slider 34 is in the first position P1, the engagement member 374 engages with the first recess 371. A force required to cancel the engagement against the urging force of the urging member acts as the resistance to the turning actuation of the knob 31.

As the knob 31 is turned clockwise in FIG. 3 from the state illustrated in FIG. 5, the slider 34 is displaced to the second position P2, as illustrated in FIG. 6. After the disengagement from the first recess 371, the engagement member 374 slides along the side wall of the rotor 32, and then engages with the second recess 372. As the resistance to the turning actuation of the knob 31 is temporarily increased, a click-feeling is generated, so that a user can recognize that the knob 31 reaches a meaningful turning angular position. The same applies to a case where the slider 34 is returned from the second position P2 to the first position P1.

When the knob 31 is turned counterclockwise in FIG. 3 from the state illustrated in FIG. 5, the slider 34 is displaced to the third position P3, as illustrated in FIG. 7. After the disengagement from the first recess 371, the engagement member 374 slides along the side wall of the rotor 32, and then engages with the third recess 373. As the resistance to the turning actuation of the knob 31 is temporarily increased, a click-feeling is generated, so that a user can recognize that the knob 31 reaches a meaningful turning angular position. The same applies to a case where the slider 34 is returned from the third position P3 to the first position P1.

Each of the first recess 371, the second recess 372, and the third recess 373 is an example of a click-feeling generative position. As the configuration for generating the click-feeling, a well-known mechanism can be appropriately employed in place of the present example.

As illustrated in FIGS. 5 to 7, the cam face 360 includes a first section S1 and a second section S2. A displacement amount of the slider 34 per unit turning angle of the knob 31 in the first section S1 is different from that in the second section S2. Specifically, the first section S1 is configured such that the displacement amount of the slider 34 per unit turning angle of the knob 31 is made larger than that in the second section S2.

As illustrated in FIG. 5, the turning angle of the knob 31 required for displacing the slider 34 from the first position P1 to the second position P2 is θ1. The turning angle of the knob 31 required for displacing the slider 34 from the first position P1 to the third position P3 is θ2. The angle θ1 and the angle θ2 are equal to each other. On the other hand, the displacement amount D1 from the first position P1 to the second position P2 of the slider 34 caused by the turning action of the knob 31 with the angle θ1 is larger than the displacement amount D2 from the first position P1 to the third position P3 of the slider 34 caused by the turning action of the knob 31 with the angle θ2.

As described above, the first position P1, the second position P2, and the third position P3 of the slider 34 are associated with the click-feeling generative positions at which the resistance to the turning actuation of the knob 31 is increased by the click-feeling generation mechanism 37. Accordingly, the first section S1 and the second section S2 of the cam face 360 are also associated with the click-feeling generative positions.

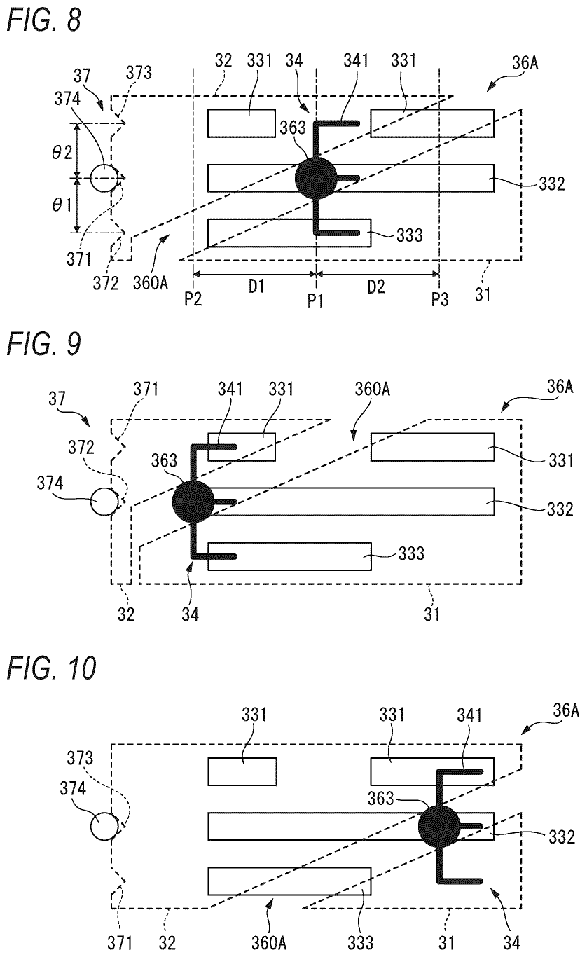

FIGS. 8 to 10 show a cam mechanism 36A according to a comparative example. The cam mechanism 36A includes a cam face 360A. The cam face 360A is different from the cam face 360 in that the displacement amount of the slider 34 per unit turning angle of the knob 31 is constant. Other components common to the cam mechanism 36 are assigned with the same reference numerals, and repetitive descriptions for those will be omitted. The states illustrated in each of FIGS. 8, 9, and 10 correspond to the states illustrated in FIGS. 5, 6, and 7, respectively.

Also in this comparative example, the turning angle ∂1 of the knob 31 required for displacing the slider 34 from the first position P1 to the second position P2 is equal to the turning angle θ2 of the knob 31 required for displacing the slider 34 from the first position P1 to the third position P3. On the other hand, since the cam face 360A is configured such that the displacement amount of the slider 34 per unit turning angle of the knob 31 is made constant, the displacement amount D1 of the slider 34 from the first position P1 to the second position P2 caused by the turning action of the knob 31 with the angle θ1 is equal to the displacement amount D2 of the slider 34 from the first position P1 to the third position P3 caused by the turning action of the knob 31 with the angle θ2.

In other words, once the click-feeling generative positions are determined with equal turning angular intervals, a displacement amount of the slider 34 while the knob 31 is turned from one click-feeling generative position to another shall take a constant value.

On the other hand, as described with reference to FIGS. 5 to 7, according to the configuration of the present exemplary embodiment, even if the click-feeling generative positions are determined with equal turning angular intervals relative to the knob 31, a displacement amount of the slider 34 associated with a transition between certain controlled states can be made different from a displacement amount of the slider 34 associated with a transition between other controlled states. In other words, it is possible to realize different motions of the slider 34 based on the same actuation of the knob 31 without changing the configuration of the click-feeling generation mechanism 37.

For example, in a case where the transition between the controlled states is made based on a change in the electrical connection state between the conductive contacts as in the present exemplary embodiment, it is required to secure enough length of a section in which the movable contact comes in contact with the stationary contact during the displacement of the slider 34. It is preferable that a section in which the electrical connection can be maintained for a longer time is associated with a transition to a controlled state with a higher priority. Accordingly, it is preferable to configure the cam face 360 in such a section so as to have a larger displacement amount of the slider 34 per unit turning angle of the knob 31.

In the comparative example described with reference to FIGS. 8 to 10, once a displacement amount of the slider 34 required for a transition between the controlled states is determined in advance, a turning amount of the knob 31 for realizing such a displacement as well as the click-feeling generative positions shall be uniquely determined in accordance with an angle of the cam face 360A relative to the turning axis A as viewed from a direction orthogonal to the turning axis A.

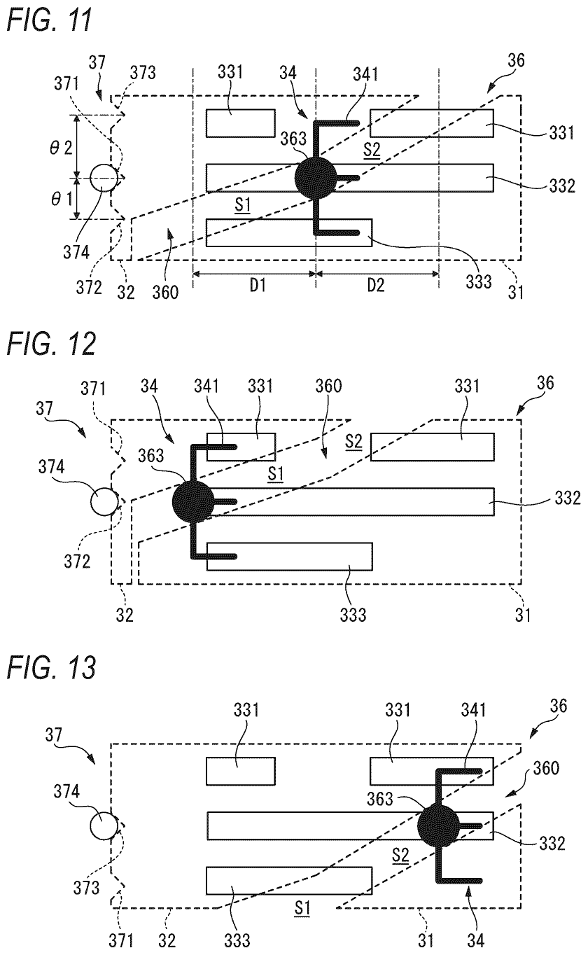

FIGS. 11 to 13 illustrate actions of the cam mechanism 36 in the knob switch 3 according to another exemplary configuration. In this example, the first position P1, the second position P2, and the third position P3 of the slider 34 associated with different controlled states are arranged with a constant interval relative to a direction along the turning axis A. Since the motion of the slider 34 is the same as the comparative example described with reference to FIGS. 8 to 10, also the layout of the stationary contacts is made the same as the comparative example.

On the other hand, since the cam face 360 is formed so as to have multiple sections in which the displacement amount of the slider per unit turning angle of the knob 31 is changed, the turning angle θ1 of the knob 31 required to displace the slider 34 from the first position P1 to the second position P2 is different from the turning angle θ2 of the knob 31 required to displace the slider 34 from the first position P1 to the third position P3.

Specifically, the displacement amount D1 of the slider 34 from the first position P1 to the second position P2 is equal to the displacement amount D2 of the slider 34 from the first position P1 to the third position P3, but the turning angle θ1 of the knob 31 required for obtaining the displacement amount D1 is smaller than the turning angle θ2 of the knob 31 required for obtaining the displacement amount D2.

Accordingly, an actuation amount of the knob 31 associated with a transition between certain controlled states can be made different from an actuation amount of the knob 31 associated with a transition between other controlled states without changing the displacement amount of the slider 34. In other words, it is possible to realize different actuation feelings of the knob 31 for causing the slider 34 to perform the same motion without changing the configuration of the slider 34.

As has been described above, according to the configuration of the present exemplary embodiment, since the cam face 360 is formed so as to have multiple sections in which the displacement amount of the slider per unit turning angle of the knob 31 is changed, it is possible to improve flexibility as for the relationship between the turning angle of the knob 31 between the click-feeling generative positions associated with the transition between different controlled states and the displacement amount of the slider 34, without applying significant change to the configuration of the slider 34 or the click-feeling generation mechanism 37. Accordingly, it is possible to improve adaptability with respect to a specification change of the switch device 1 in accordance with a change of an object to be controlled.

In the present exemplary embodiment, the cam face 360 is configured such that the displacement amount of the slider 34 per unit turning angle of the knob 31 is changed at the click-feeling generative position of the click-feeling generation mechanism 37. Specifically, an intersecting angle of the cam face 360 with respect to the turning axis A as viewed from the direction orthogonal to the turning axis A is changed at a position corresponding to the first recess 371 of the click-feeling generation mechanism 37.

Accordingly, the actuation feeling of the knob 31 changes at this position. Since the actuation feeling of the knob 31 is changed in addition to the click feeling provided by the click-feeling generation mechanism 37, it is possible to cause the user to more reliably recognize the transition between sections divided by the click-feeling generative position so as to correspond to different controlled states.

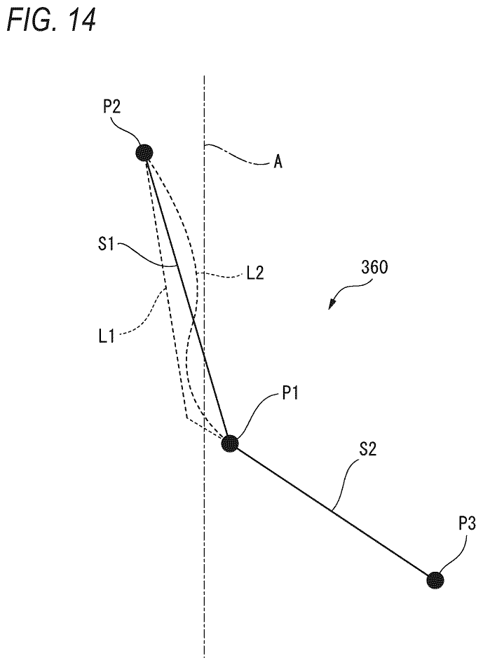

FIG. 14 schematically illustrates an inclination of the cam face 360 with respect to the turning axis A as viewed from the direction orthogonal to the turning axis A. The left-right direction in the drawing corresponds to the turning direction of the knob 31. The up-down direction in the drawing corresponds to the displacement direction of the slider 34. Accordingly, the steeper inclination of the straight line represents the larger displacement amount of the slider 34 per unit turning angle of the knob 31.

In the above exemplary embodiment, in each of the first section S1 and the second section S2 included in the cam face 360, the displacement amount of the slider 34 per unit turning angle of the knob 31 takes a constant value. However, as indicated by dashed lines, the cam face 360 may be configured to change the displacement amount of the slider 34 per unit turning angle of the knob 31 at least once in at least one of the first section S1 and the second section S2. The way of change may be stepwise as indicated by dashed lines L1, or may be continuous as indicated by dashed lines L2.

According to such a configuration, since it is possible to make the actuation feeling of the knob 31 variable within a section associated with a transition between certain controlled states, adaptation can be realized with respect to more diverse requests for the specification change.

In this case, it is preferable to configure the cam face 360 such that the displacement amount of the slider 34 per unit turning angle of the knob 31 is decreased in at least one end portion of each section. According to such a configuration, since the slider 34 temporarily decelerates before moving to an adjacent section that is associated with different displacement amount of the slider 34 per unit turning angle of the knob 31, smooth transition of the slider 34 to the adjacent section can be realized.

Each configuration described above is merely illustrative in order to facilitate understanding of the presently disclosed subject matter. Each of the above exemplary configurations can be appropriately modified or combined with another exemplary configuration within the teaching of the presently disclosed subject matter.

In the above-described switch device 1, the cam face 360 includes two sections associated with different displacement amounts of the slider 34 per unit turning angle of the knob 31. However, the cam face 360 may include three or more sections associated with different displacement amounts of the slider 34 per unit turning angle of the knob 31.

In the above-described switch device 1, a relationship of N=M−1 is established between the number N of sections included in the cam face 360 that are associated with different displacement amounts of the slider 34 per unit turning angle of the knob 31 and the number M of the click-feeling generative positions provided by the click-feeling generation mechanism 37. However, the relationship between the two numbers can be appropriately changed according to the specification of the switch device 1.

In the above-described switch device 1, the selection from the multiple controlled states is performed by establishing any one of multiple electrical connection states between the movable contact 341 provided on the slider 34 and at least one of the stationary contacts provided on the board 33. However, the position of the slider 34 displaced by the cam face 360 of the cam mechanism 36 may be detected optically or magnetically, so that selection from the multiple controlled states may be performed based on the position as detected.

In the above-described switch device 1, the slider 34 is accommodated in the housing 35 having a shape elongated in the direction along the turning axis A of the knob 31. In this case, it is possible to alleviate the restriction on the displacement of the slider 34 in the direction along the turning axis A implemented by the cam mechanism 36.

However, as long as the cam mechanism 36 includes such a cam face 360 that displaces the slider 34 in the direction along the turning axis A in accordance with the turning action of the knob 31 about the turning axis A, the form of the switch device 1 can be appropriately changed.

The switch device 1 described above constitutes a part of the steering device for changing the traveling direction of the vehicle. The multiple controlled states to be selected based on the turning actuation of the knob 31 correspond to multiple operations to be performed by the headlight installed in the vehicle. However, the multiple controlled states to be selected based on the turning actuation of the knob 31 may be multiple operations to be performed by another device installed in the vehicle. Examples of another device include another lighting device, a wiper device, and an opening/closing device for a door or a window.

The switch device 1 described above may not constitute a part of the steering device. The switch device 1 may be disposed at an appropriate position in the vehicle to control the operation of another device installed in the vehicle based on the turning actuation of the knob 31. Examples of another device include an audio-visual device, an air conditioning device, and a navigation device.

The above-described switch device 1 may not be installed in a vehicle. The switch device 1 may be disposed at an appropriate position in a house or a facility to control the operation of various devices disposed in the house or the facility based on the turning actuation of the knob 31.

The present application is based on Japanese Patent Application No. 2023-063545 filed on Apr. 10, 2023, the entire contents of which are incorporated herein by reference.

1. A switch device, comprising:
a knob that is turnable about an axis;
a slider;
a cam mechanism having a cam face configured to displace the slider in a direction along the axis in accordance with a turning action of the knob; and
a click-feeling generation mechanism configured to increase resistance to an actuation for turning the knob as the slider arrives each of multiple prescribed positions;
wherein the cam face has multiple sections in which a displacement amount of the slider per unit turning angle of the knob is changed; and
wherein the multiple sections are associated with a click-feeling generative position at which the resistance is increased by the click-feeling generation mechanism.

2. The switch device according to claim 1,
wherein the cam face is configured such that the displacement amount of the slider per unit turning angle of the knob is changed at a position corresponding to the click-feeling generative position.

3. The switch device according to claim 1,
wherein the cam face is configured such that the displacement amount of the slider per unit turning angle of the knob is made constant in at least one of the multiple sections.

4. The switch device according to claim 1,
wherein the cam face is configured such that the displacement amount of the slider per unit turning angle of the knob is changed at least once in at least one of the multiple sections.

5. The switch device according to claim 4,
wherein the cam face is configured such that the displacement amount of the slider per unit turning angle of the knob is decreased in at least one end portion of the at least one of the multiple sections.

6. The switch device according to claim 1,
wherein the slider is provided with a movable conductive contact;
wherein a displacement path of the slider is provided with stationary conductive contacts; and
wherein the movable conductive contact is configured to establish an electrical connection state with at least one of the stationary contacts in accordance with displacement of the slider.

7. The switch device according to claim 6,
wherein the cam face is configured such that the displacement amount of the slider per unit turning angle of the knob is more increased in the multiple sections that are associated with a transition to a controlled state with a higher priority.

8. The switch device according to claim 1,
wherein the slider is accommodated in a housing elongated in the direction along the axis.

9. The switch device according to claim 1,
wherein the switch device constitutes a part of a steering device for changing a traveling direction of a vehicle; and
wherein the multiple prescribed positions correspond to multiple operations performed by at least one device installed in the vehicle.
